(19) United States
(12) Patent Application Publication
(10) Pub. No.: US 2012/0198659 A1
(43) Pub. Date: Aug. 9, 2012

(54) ANTI-DERAILMENT DEVICE FOR LIFT OR ELEVATOR DOOR LEAVES

(75) Inventor: Paolo Giorgioni, Ligonchio (IT)

(73) Assignee: WITTUR S.P.A., 43052 Colorno (Parma) (IT)

(21) Appl. No.: 13/500,783

(22) PCT Filed: Jul. 29, 2010
(86) PCT No.: PCT/IT2010/000341

§ 371 Date: Apr. 6, 2012

(30) Foreign Application Priority Data
Oct. 9, 2009 (IT) PR2009A000078

(51) Int. Cl. B66B 13/30

(52) U.S. Cl. 16/93 R

(57) ABSTRACT

An anti-derailment device for lift or elevator door leaves (2), of the type provided with at least one guide shoe (4) at the lower or upper end thereof, suitable for sliding in a groove (5) formed in a lower sill (6) of the door or defined in an upper recess of the door, is characterised in that it comprises an element (9), associated with the shoe (4) or with the leaf (2), which is shaped like a hook so as to interact with at least one bent edge (11) of the groove (5), hooking thereto in response to a stress on the leaf (2) which tends to produce a derailment of the shoe (4).

### TECHNICAL FIELD AND BACKGROUND ART

The present invention relates to an anti-derailment device for lift or elevator door leaves.

The device can be applied to sliding doors with central opening of the leaves or with side telescopic opening, with linear and curvilinear sliding leaves, with leaves having a mechanism situated in the upper zone of the leaves and with leaves having a mechanism positioned at the bottom.

The landing doors of lifts or elevators are normally provided at the bottom with shoes that slide in a groove formed in the sill and have the purpose of keeping the leaves inside the guide during the opening and closing movement that occurs when the car is at the landing door.

However, stresses, impacts and shoves on the door from the outside could cause the shoes to derail from their sliding groove, thus freeing the door from the lower constraint and dangerously allowing the door to provide free access to the lift or elevator shaft, also in the absence of the car.

In order to avoid this possibility, up to now manufacturers of doors for lifts or elevators have sought to produce very sturdy, heavy doors, such as to withstand high stresses.

However, this gives rise to significant costs for said doors in order that the meet the necessary resistance and safety requirements.

WO 2009/128686 A2, WO 2009/128688 A2 and WO 2008/108556 A1 disclose anti-derailment devices which are, however, complex or scarcely effective since they lack a solid hooking mechanism between the sill and leaf.

US 2001/010426 A1 shows a well-known upper anti-derailment device associated with the movement/sliding mechanism and not with the guide recess, so that it is not proposed at the bottom in the sill.

U.S. Pat. No. 7,424,935 B1 also shows a lift door of a known type that does not overcome the previously mentioned limitations.

In this context, the technical task at the basis of the present invention is to propose an anti-derailment device that overcomes the limitations of the above-mentioned prior art.

### DISCLOSURE OF THE INVENTION

In particular, it is an object of the present invention to provide an extremely simple and economical anti-derailment device capable of intervening whenever a stress of such intensity and direction is applied on the door that the leaves would tend to bend and derail, that is the guide shoes of the leaves would tend to come out of the respective sliding grooves.

A further object of the present invention is to propose a device that can be easily applied also to already existing and installed leaves.

A further object is to render the intervention of the anti-derailment device automatic in the event of heating of the door due to fire.

The defined technical task and the specified objects hereof are substantially achieved by an anti-derailment device comprising the technical characteristics described in one or more of the appended claims.

### BRIEF DESCRIPTION OF DRAWINGS

Further characteristics and advantages of the present invention will become more apparent from the following approximate, and hence non-restrictive, description of a preferred, but not exclusive, embodiment of an anti-derailment device as illustrated in the appended drawings, in which:

FIG. 1 schematically shows an overall door;

FIG. 2 illustrates a detail of the door in FIG. 1, in the same frontal view;

FIG. 3 illustrates the detail of FIG. 2 in a lateral cross-section view;

FIG. 4 illustrates the door in the case in which the sliding groove of the shoes is positioned at the top;

FIG. 5 illustrates a lateral cross-section view of a detail of the door according to a variant embodiment;

FIG. 6 illustrates a lateral cross-section view of a variant of the method for fixing the device to the leaf;

FIGS. 7 and 8 illustrate a lateral cross-section view of variant embodiments of anti-derailment devices constructed from a bi-material, in two distinct operating conditions;

FIG. 9 illustrates a lateral cross-section view of a variant in which the device and sill are provided with a double hook;

FIGS. 10, 11 and 12 illustrate other views of the variant of the device in FIG. 9.

### BEST MODE FOR CARRYING OUT THE INVENTION

With reference to the figures, 1 indicates an overall door for lifts or elevators composed of one or more sliding leaves 2.

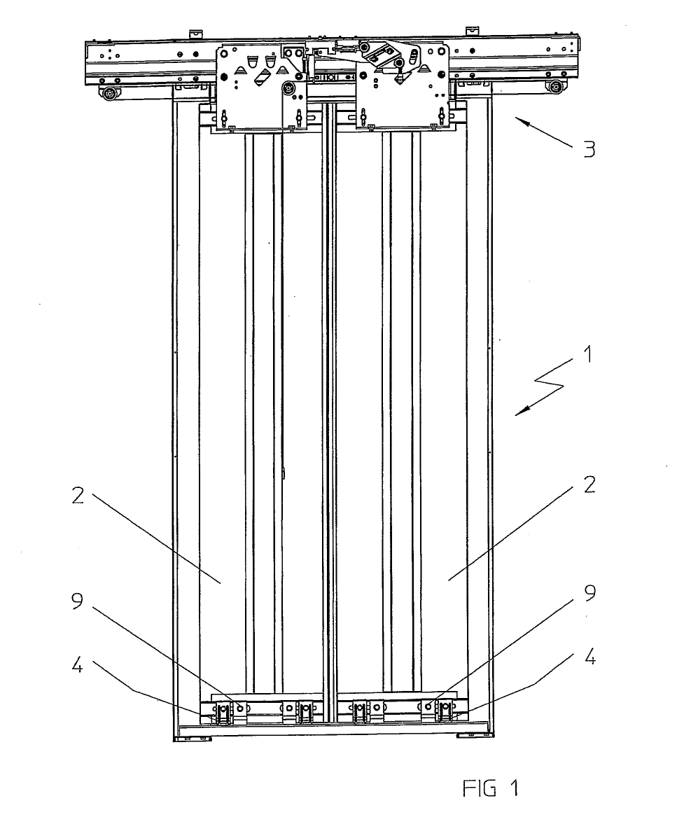

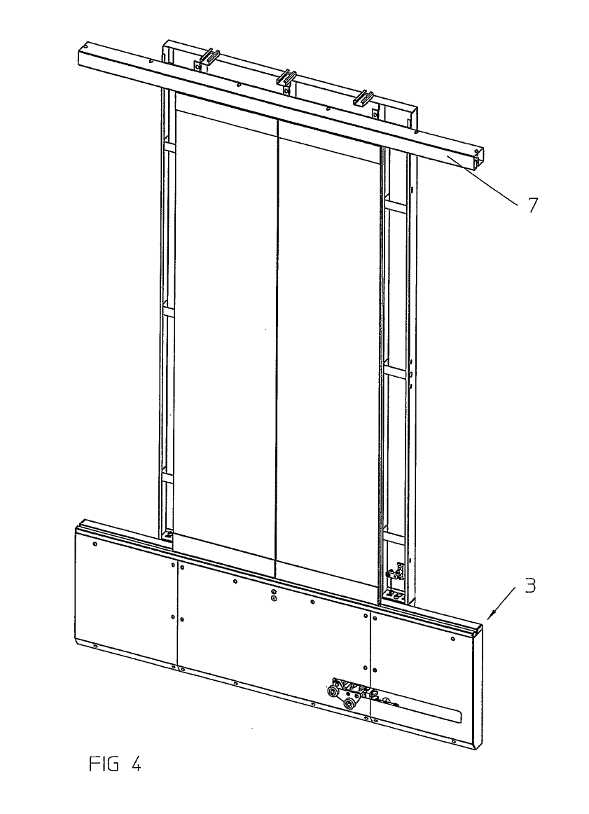

The door is equipped with an apparatus for moving the leaves, indicated overall by the number 3 and of a substantially known type, which can be positioned in the upper zone of the door (as illustrated in FIG. 1) or in the lower zone (as illustrated in FIG. 4).

In both cases the door leaves are provided with shoes 4 sliding in a groove 5.

More precisely, the shoes 4 consist of a portion fixed to the leaf (for example by means of screws or bolts) and a portion (normally of a different material) which slides in the groove 5.

The portion fixed to the leaf is normally of metal (iron, steel, aluminium, . . . ), whereas the sliding portion, in the form, for example, of a wheel or pad, is preferably of a plastic material, for example coating an inner metal core.

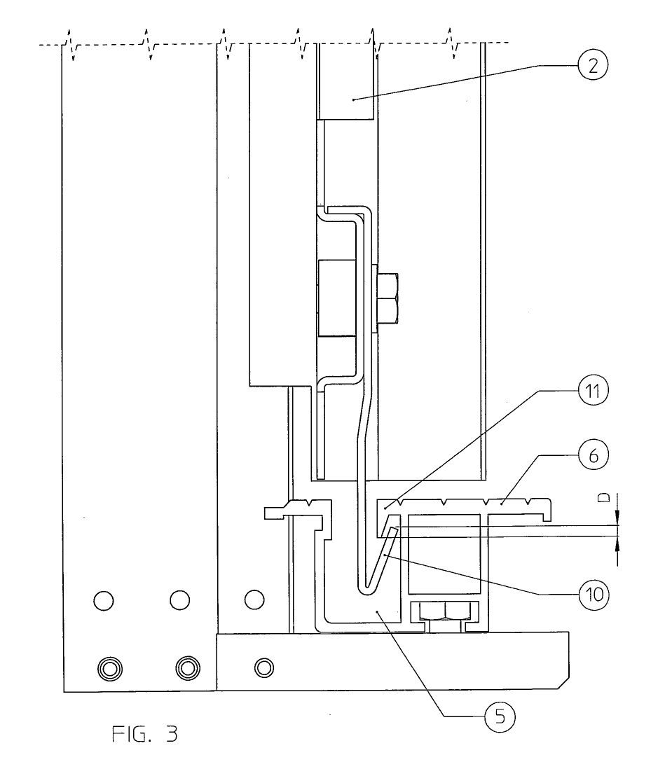

In the case of a door with a movement apparatus situated at the top (FIGS. 1-3), the shoes 4 are fixed to the leaf at the bottom and slide in a groove 5 formed in the landing sill 6 of the lift or elevator.

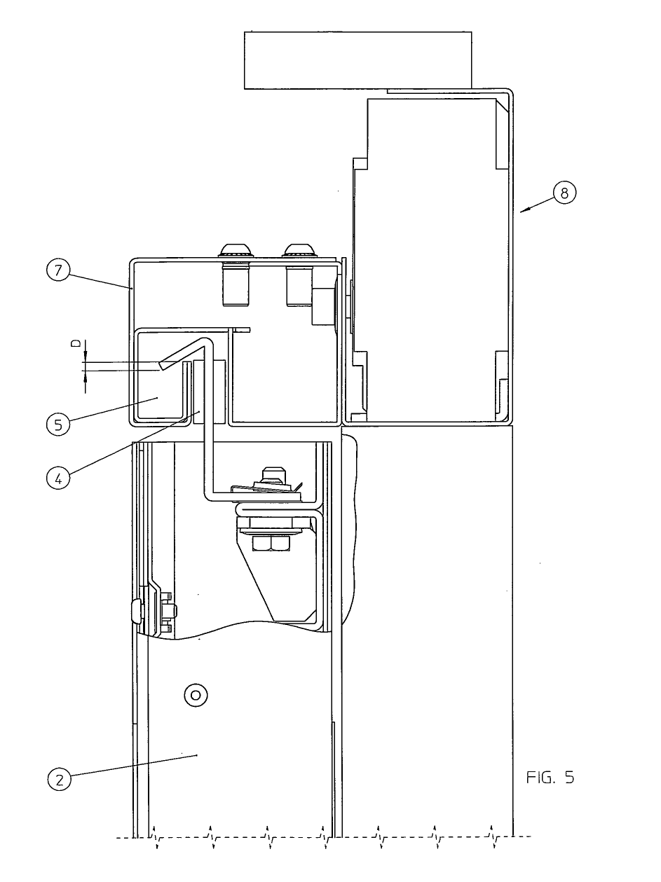

In the case of a door with a movement apparatus situated at the bottom (FIGS. 4-5), the shoes 4 are fixed to the leaf at the top and slide in a groove formed in a bar 7 associated with a fixed frame 8 of the door, or directly anchored to a wall where the frame 8 is not present.

In both cases the door innovatively comprises a plurality of anti-derailment elements 9, which in a first embodiment can be associated with the leaves (FIGS. 1, 2, 3, 6), for example by means of screws or bolts, in a position substantially alongside the shoes 4, whereas in a second embodiment (FIG. 5) they can be associated with the shoes 4.

Each element 9, which constitutes an anti-derailment device, has substantially the form of a clip with one end 10 bent like a hook (in an opposite direction relative to the lift car, not illustrated, or else toward the car) and configured in such a way that, in the presence of stress on the door tending to cause a derailment thereof, said end 10 will hook to a bent edge 11 defining the groove, thus preventing any possible derailment of the leaf.

The element 9 is bent like a hook in the sense that its end 10 is bent inward and forms an acute angle.

Moreover, the end 10 is preferably configured in such a way as to extend inside the groove 5 and D indicates the extent of the interference (difference in level) between the terminal part of the end 10 and the terminal part of the edge 11 of the groove.

Said interference (preferably >1 mm) favours the hooking between the end 10 and the edge 11 to prevent the derailment of the leaf in the event of anomalous stresses.

According to the applications, the element 9 can be constructed from various materials such as iron, steel, aluminium or plastic materials.

However, construction from plastic materials, which are not fire resistant, may render the anti-derailment ineffective in the event the door catches fire.

The portion of the device fixed to the leaf and the portion sliding in the groove can also be of different materials.

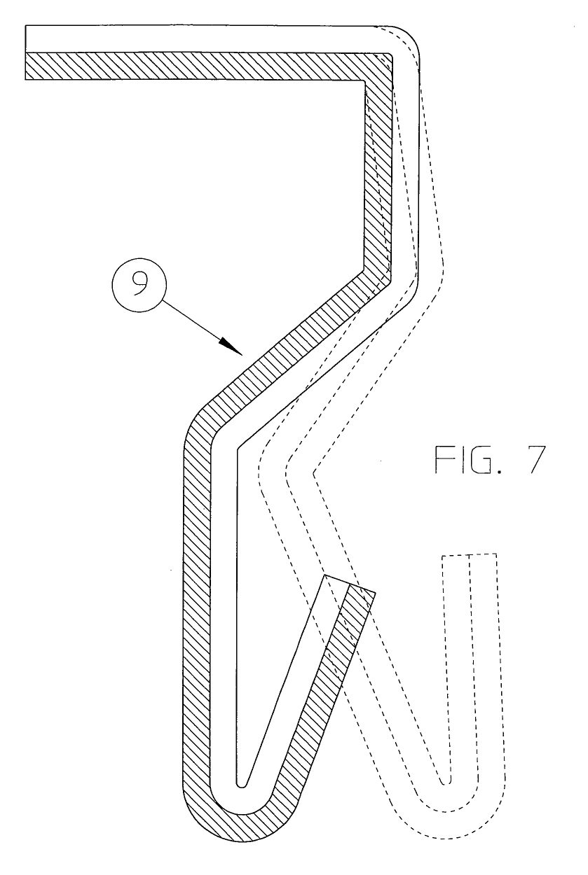

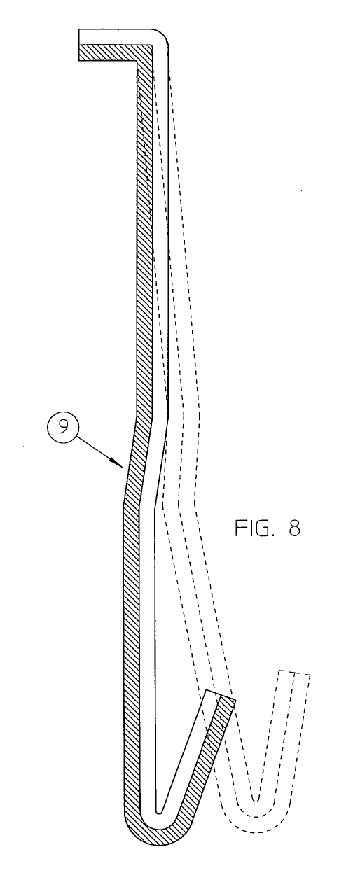

FIGS. 7 and 8 illustrate a variant embodiment in which the element 9 (associated with the leaf and not with the shoe) is formed by joining two materials having a different thermal expansion coefficient.

For example, an outer material (indicated by hatching) having a higher expansion coefficient is associated with an inner material having a lower expansion coefficient.

In the event of a fire, the difference between the thermal expansion coefficients of the two materials will cause a different expansion thereof, resulting in the bending of the element 9 (illustrated by hatching in the figures) and the automatic hooking thereof to the edge 11 of the groove.

The aforesaid materials substantially constitute a thermal couple or thermoelectric couple.

In order to construct a thermal couple, numerous combinations of metals and alloys can be used, including for example copper-constantan, platinum-platinum and rhodium, iron-constantan, tungsten-tungsten and rhodium, chromel-constantan or chromel-alumel.

The edge 11 of the groove, which is interrupted after a few centimetres so as to define a sort of natural hook in the sill 6 or bar 7, also has the purpose of reducing the contact surface between the shoe 4 and the walls of the groove itself.

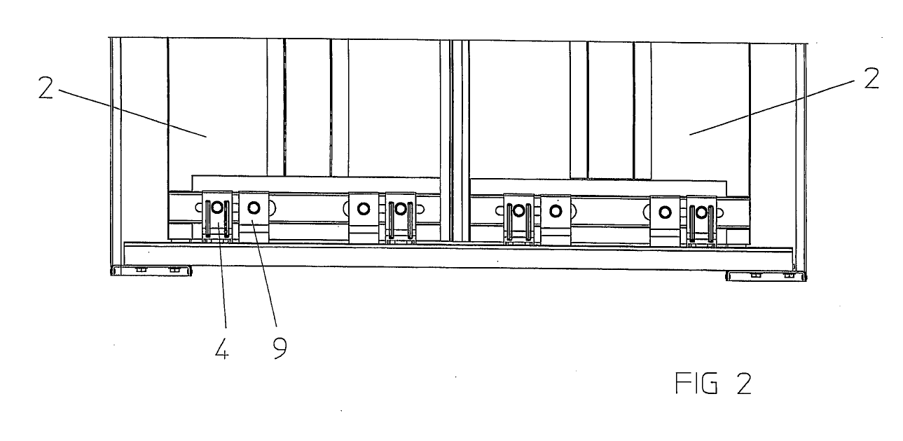

The anti-derailment elements 9, as previously said, can be fixed directly to the leaf 2 alongside the shoes 4 as illustrated in FIG. 2.

In this case the elements 9 can be easily installed also on existing leaves, already in use, by inserting them vertically into the groove 5 and then fixing them to the leaf with screws or bolts.

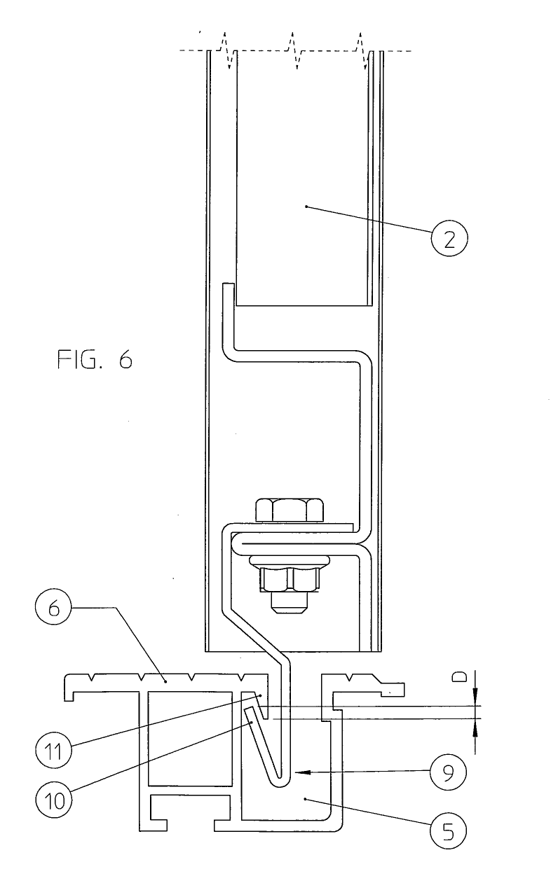

Fixing to the leaf 2 can take place in a frontal position (with screws or bolts along a substantially horizontal axis), or else it can take place from above, as is illustrated for example in FIG. 6, where the element 9 has one horizontally bent end that is coupled with a horizontal portion of a C-shaped profile of the leaf and the fastening screws or bolts are substantially vertical.

The case illustrated refers to an anti-derailment element mounted in the lower position of the leaf, but the same solution can be applied, according to need, in the upper position of the leaf.

The anti-derailment elements 9, can also be incorporated in the shoes, as shown for example in FIG. 5.

The element 9 substantially passes through the portion of shoe sliding in the groove and extends beyond it so as to be able to hook, in case of need, to the edge 11 of the groove.

In this case, in order to insert or replace an element 9, it will not be possible to act vertically; it will be necessary to pull it out from groove by sliding it sideways until it comes out laterally from the end of the groove itself, or from the end of the lower sill 6 or the upper bar 7.

This greater difficulty is however compensated for by the fact of having a single element which performs the functions both of a shoe and an anti-derailment device.

The anti-derailment elements 9 are preferably at least two in number, positioned at the bottom or at the top, according to the type of door.

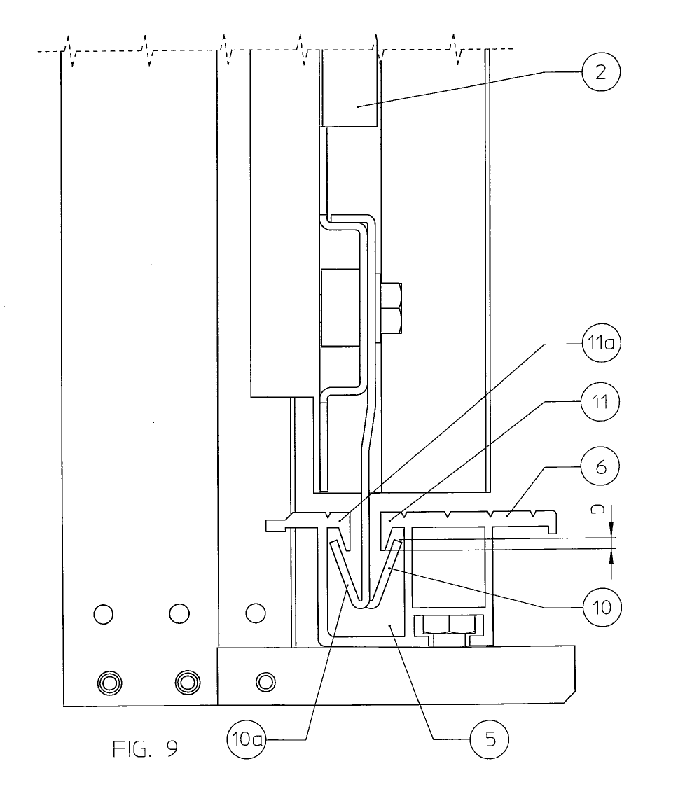

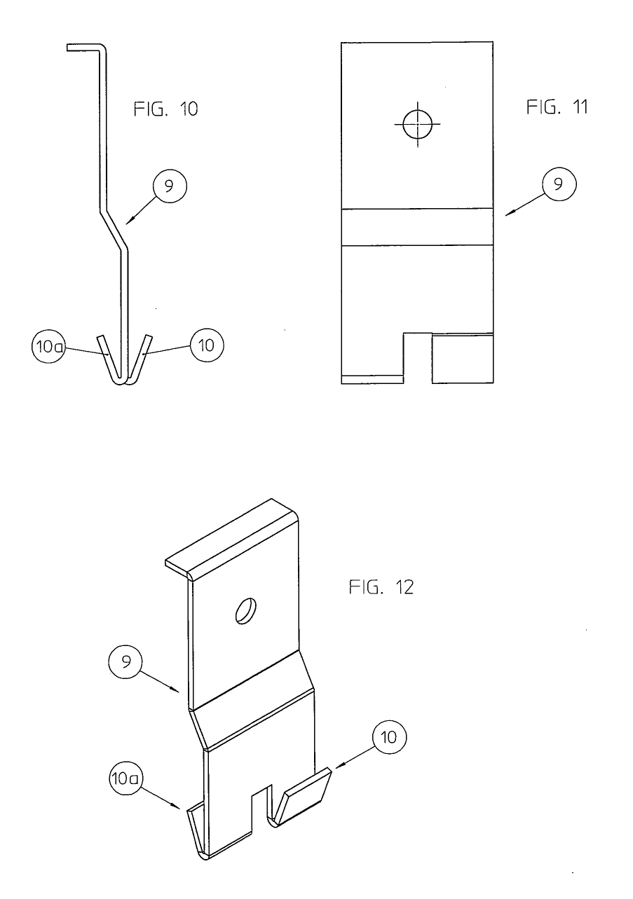

With reference to FIGS. 9 to 12, they refer to a further variant embodiment in which the element 9 has two ends 10 and 10a bent like hooks on opposite sides of the element 9 and such as to respectively hook to the edge 11 and to an additional edge 11a of the groove 5.

1. An anti-derailment device for lift or elevator door leaves (2), of the type provided with at least one guide shoe (4) at the lower or upper end thereof, suitable for sliding in a groove (5) formed in a lower sill (6) of the door or defined in the upper zone of the door, characterised in that it comprises an element (9), associated with the shoe (4) or with the leaf (2), which is shaped like a hook in the sense that one end (10) thereof forms an acute angle so as to hook to at least one corresponding bent edge (11) hook-like shaped of the groove (5) defining an interference (D) between the terminal part of the end (10) and the terminal part of the edge (11) of the groove in response to a stress on the leaf (2) which tends to produce the derailment of the shoe (4).

2-3. (canceled)

4. The device according to claim 1, wherein the extent of said interference (D) is greater than 1 mm.

5. The device according to claim 1, wherein the element (9) is an integral part of the shoe (4) and has a hook-like shape suitable for hooking to the corresponding bent shape of the edge (11) of the groove (5).

6. The device according to claim 1, wherein the element (9), in the form of a clip, passes through the shoe (4) and extends beyond the latter with its active end intended to hook, in case of need, to the edge (11) of the groove (5).

7. The device according to claim 1, wherein the element (9) is a clip applied to the leaf (2), wherein the clip has a hook-like shape suitable for hooking to the corresponding hook-like shape of the edge (11) of the groove (5).

8. The device according to claim 1, wherein there are at least two shoes (4) and at least two elements (9).

9. The device according to claim 1, wherein the element (9) has a hook-like shape bent in an opposite direction to the side where the lift or elevator car is standing.

10. The device according to claim 1, wherein the element (9) has a hook-like shape bent toward the side where the lift or elevator car is standing.

11. The device according to claim 1, wherein the portion of the element (9) fixed to the leaf (2) may be either horizontal or vertical.

12. The device according to claim 1, wherein the element (9) has two ends (10 and 10a) bent like hooks on opposite sides of the element (9) and such as to hook respectively to the edge (11) and an additional edge (11a) of the groove (5).

13. An anti-derailment device for lift or elevator door leaves (2), of the type provided with at least one guide shoe (4) at the lower or upper end thereof, suitable for sliding in a groove (5) formed in a lower sill (6) of the door or defined in the upper zone of the door,
characterised in that it comprises an element (9), associated with the leaf (2), which is shaped like a hook and constructed from a bi-material, wherein the element (9) has two opposing faces of different materials forming a thermal couple, the materials constituting each of the two faces having different thermal expansion coefficients so that the element (9) will hook to at least one corresponding bent edge (11) of the groove (5) in response to a heating stress of the leaf (2).
